(19) United States
(12) Patent Application Publication
(10) Pub. No.: US 2013/0193937 A1
(43) Pub. Date: Aug. 1, 2013

(54) SWITCHING REGULATOR AND ELECTRONIC APPARATUS

(71) Applicant: Kabushiki Kaisha Toshiba, Tokyo (JP)

(72) Inventor: Yutaka HORIE, Mitaka-shi (JP)

(73) Assignee: Kabushiki Kaisha Toshiba, Tokyo (JP)

(21) Appl. No.: 13/693,761

(22) Filed: Dec. 4, 2012

(30) Foreign Application Priority Data
Jan. 31, 2012 (JP) 2012-017978

(51) Int. Cl. G05F 1/595

(52) U.S. Cl. CPC G05F 1/595
USPC 323/271

(57) ABSTRACT

According to one embodiment, a switching regulator includes a switching controller, a driver, a detector, and an adjustment module. The switching regulator outputs a first switch control signal for controlling switching of a high-side transistor and a second switch control signal for controlling switching of a low-side transistor. The driver supplies an output signal for driving the high-side transistor to a gate of the high-side transistor in accordance with the first switch control signal. The detector detects a ringing voltage on a switching node between the high-side transistor and the low-side transistor. The adjustment module adjusts a level of the output signal of the driver so as to decrease the level if the detected ringing voltage exceeds a threshold value.

### CROSS-REFERENCE TO RELATED APPLICATIONS

This application is based upon and claims the benefit of priority from prior Japanese Patent Application No. 2012-017978, filed Jan. 31, 2012, the entire contents of which are incorporated herein by reference.

### FIELD

Embodiments described herein relate generally to a switching regulator and electronic apparatus.

### BACKGROUND

Recently, in electronic apparatuses such as personal computers (PCs) and television sets, low power consumption and downsizing of components of the electronic apparatuses have progressed. In particular, as the semiconductor technologies advance, components such as CPU and memory module have become able to operate at lower voltages than conventional voltages. Therefore, a DC-DC converter is used to apply, to each component of an electronic apparatus, a power supply voltage lower than a power supply voltage to be applied to the electronic apparatus.

There are various kinds of DC-DC converters. As an example, a switching DC-DC converter is known. This switching DC-DC converter converts an input voltage into a desired output voltage by alternately controlling the switching of a high-side FET and low-side FET. The switching DC-DC converter can apply the converted output voltage as electric power to each component. This switching DC-DC converter can stably apply a desired voltage by controlling the ON-duty ratio of the high-side FET. Also, high performance (process evolution) of the high-side FET allows it to perform high-speed switching. Since the energy loss by switching can be reduced, it is becoming possible to increase the power efficiency.

Recently, however, the ON-resistance of an internal driver of the DC-DC converter is lower, and the switching speed of the high-side FET is increasing. This sometimes increases the level of ringing noise in case that the high-side FET is turned-on, in comparing to the conventional noise level. In this case, the switching noise propagates to a system control signal or the like, and the operation of a system including a plurality of components sometimes becomes unstable.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing the outer appearance of an electronic apparatus according to an embodiment;

FIG. 2 is an exemplary block diagram showing the system configuration of the electronic apparatus according to the embodiment;

FIG. 3 is an exemplary block diagram showing an example of the configuration of a switching regulator in the electronic apparatus according to the embodiment;

FIG. 4 is an exemplary view showing an example of the waveform of switching noise (ringing noise) on a switching node in the switching regulator shown in FIG. 3;

FIG. 5 is an exemplary view showing an example of the waveform of the ringing noise in case that the output level of a high-side FET driver in the switching regulator shown in FIG. 3 is decreased;

FIG. 6 is an exemplary view showing an example of the waveform of the ringing noise in case that the output level of the high-side FET driver in the switching regulator shown in FIG. 3 is further decreased relative to the case of FIG. 5;

FIG. 7 is an exemplary flowchart for explaining the procedure of the ringing noise reducing process to be executed by a control loop in the switching regulator of the embodiment; and

FIG. 8 is an exemplary block diagram showing an example of the configuration of the high-side FET driver in the switching regulator shown in FIG. 3.

### DETAILED DESCRIPTION

Various embodiments will be described hereinafter with reference to the accompanying drawings.

In general, according to one embodiment, a switching regulator includes a switching controller, a driver, a detector, and an adjustment module. The switching regulator outputs a first switch control signal for controlling switching of a high-side transistor and a second switch control signal for controlling switching of a low-side transistor. The driver supplies an output signal for driving the high-side transistor to a gate of the high-side transistor in accordance with the first switch control signal. The detector detects a ringing voltage on a switching node between the high-side transistor and the low-side transistor. The adjustment module adjusts a level of the output signal of the driver so as to decrease the level if the detected ringing voltage exceeds a threshold value.

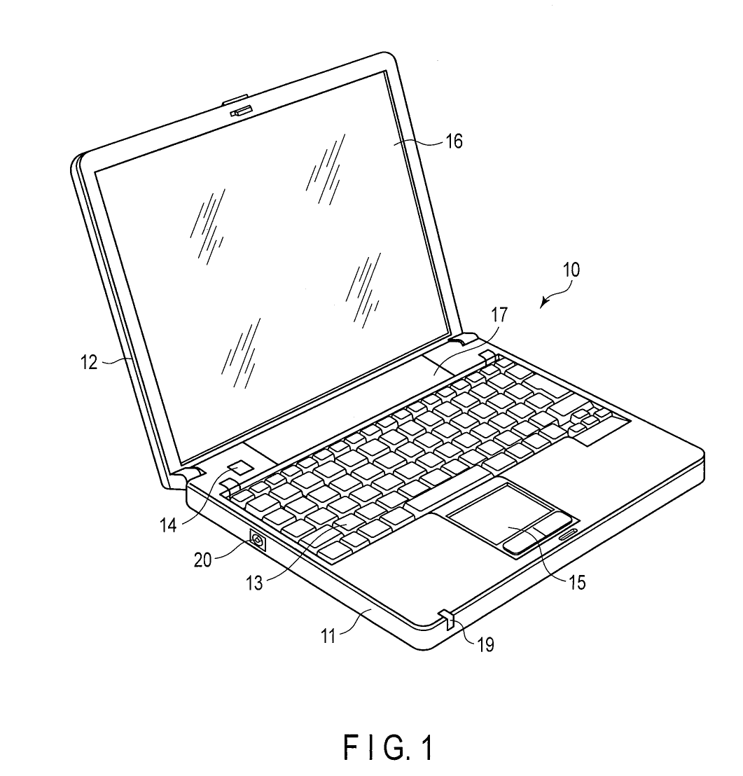

First, the configuration of the electronic apparatus according to the embodiment will be explained below with reference to FIG. 1. This electronic apparatus is implemented as, e.g., a notebook personal computer 10 drivable by an AC adaptor (external power source) or battery 17. FIG. 1 is a perspective front view of the computer 10 with a display unit being opened. The computer 10 is configured to receive electric power from the AC adaptor via a power connector 20, or from the battery 17.

The computer 10 includes a DC-DC converter for converting an input DC voltage applied from the eternal power supply or battery 17 into an output DC voltage having a predetermined value. The DC-DC converter is, e.g., a step-down switching DC-DC converter. The switching DC-DC converter generates switching noise such as the ringing noise because a switching element is rapidly switched. The ringing noise may make the operation of the internal system of the computer 10 unstable. For example, the ringing noise may propagate to a control signal in the system, and this may cause a specific phenomenon such as an operation error of the system of the computer 10 or disturbance of an image displayed on an LCD 16. In the embodiment, control for suppressing the level of the ringing noise is performed.

The computer 10 includes a computer main body 11 and display unit 12. The display unit 12 incorporates a display device including the LCD (Liquid Crystal Display) 16.

The display unit 12 is attached to the computer main body 11 rotatable between an open position where the upper surface of the computer main body 11 is exposed and a closed position where the upper surface of the computer main body 11 is covered with the display unit 12. The computer main body 11 includes a low profile housing. A keyboard 13, a power button 14 for turning on/off the computer 10, and a touchpad 15 are arranged on the upper surface of the housing.

The computer main body 11 also includes the power connector 20. The power connector 20 is formed on a side surface, e.g., the left side surface of the computer main body 11. An external power supply is detachably connected to the power connector 20. The AC adaptor can be used as the external power supply. The AC adaptor is a power supply that converts commercial power (AC power) into DC power.

The power connector 20 is comprises a jack to which the power plug of the external power supply such as an AC adaptor is detachably connectable. The battery 17 is detachably attached to, e.g., the rear end of the computer main body 11.

As described above, the computer 10 is driven by the electric power from the external power supply or the battery 17. In case that the external power supply is connected to the power connector 20 of the computer 10, the computer 10 is driven by the electric power from the external power supply. The electric power from the external power supply is also used to charge the battery 17. During a period in which the external power supply is not connected to the power connector 20 of the computer 10, the computer 10 is driven by the electric power from the battery 17.

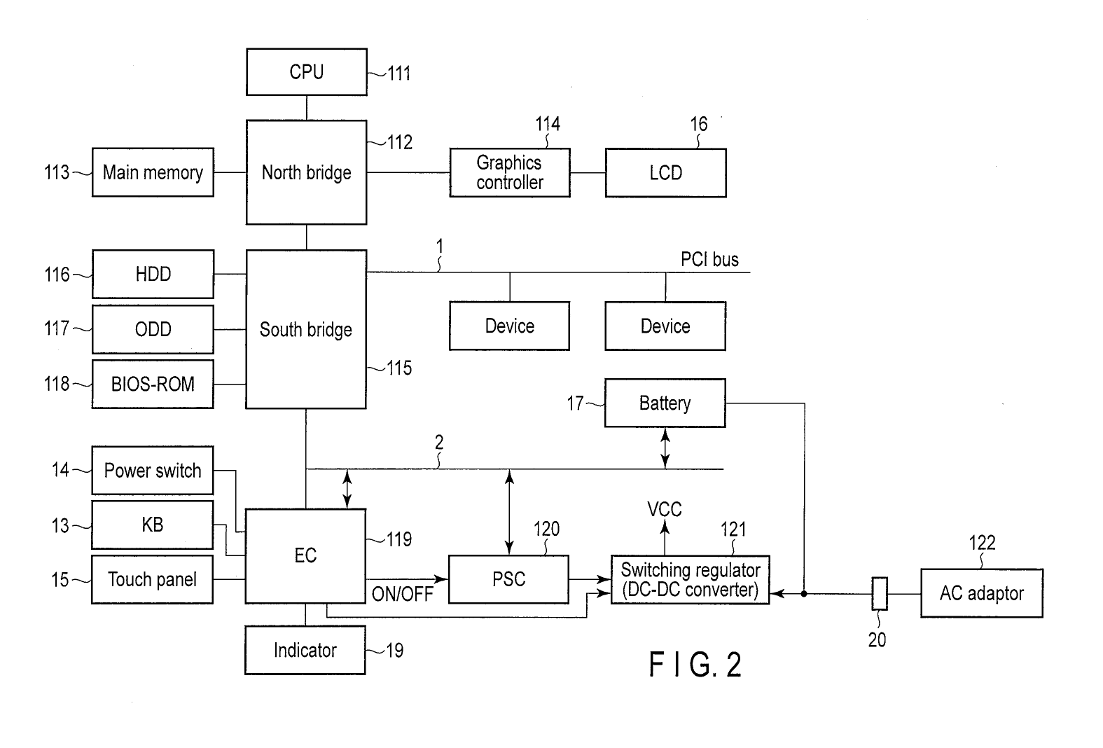

FIG. 2 shows the system configuration of the computer 10. The computer 10 includes a CPU 111, north bridge 112, main memory 113, graphics controller 114, south bridge 115, hard disk drive (HDD) 116, optical disk drive (ODD) 117, BIOS-ROM 118, embedded controller (EC) 119, power supply controller (PSC) 120, switching regulator (DC-DC converter) 121, and AC adaptor 122. The AC adaptor 122 is used as the above-described external power supply.

The CPU 111 is a processor configured to control the operation of each component of the computer 10. The CPU 111 executes various kinds of software such as an operating system (OS) and various application programs loaded into the main memory 113 from the HDD 116. The CPU 111 also executes a BIOS (Basic Input Output System) stored in the BIOS-ROM 118 as a nonvolatile memory. The BIOS is a system program for hardware control.

The north bridge 112 is a bridge device for connecting a local bus of the CPU 111 and the south bridge 115. The north bridge 112 also has a function of communicating with the graphics controller 114. Furthermore, the north bridge 112 incorporates a memory controller configured to control the main memory 113. The graphics controller 114 is a display controller configured to control the LCD 16 used as a display monitor of the computer 10.

The south bridge 115 is connected to a PCI bus 1, and communicates with each device on the PCI bus 1. Also, the south bridge 115 incorporates an IDE (Integrated Drive Electronics) controller and serial ATA controller for controlling the hard disk drive (HDD) 116 and optical disk drive (ODD) 117.

The EC 119, power supply controller (PSC) 120, and battery 17 are connected to each other via a serial bus 2. The embedded controller (EC) 119 is a power management controller configured to execute power management of the computer 10. For example, the embedded controller (EC) 119 is implemented as an one-chip microcomputer incorporating a keyboard controller for controlling the keyboard (KB) 13, touch pad 15, and the like. The EC 119 has a function of powering on and off the computer 10 in accordance with the operation of the power switch 14 by the user. The ON control and OFF control of the computer 10 can also be executed by a cooperation of the EC 119 and the power supply controller (PSC) 120. In case of receiving an ON signal transmitted from the EC 119, the PSC 120 powers on the computer 10 by controlling the switching regulator 121. In case of receiving an OFF signal transmitted from the EC 119, the PSC 120 powers off the computer 10 by controlling the switching regulator 121. Even if the computer 10 is kept OFF, the EC 119, the PSC 120, and switching regulator 121 can receive electric power from the AC adaptor 122 or battery 17.

By using the electric power from the battery 17 attached to the computer main body 11 or the electric power from the AC adaptor 122 connected as the external power source to the computer main body 11, the switching regulator 121 generates electric power to be supplied to each component. In other words, the switching regulator 121 generates electric power (operating power) for operating each component. In case that the AC adaptor 122 is connected to the computer main body 11, the switching regulator 121 can generate the operating power for each component and can also charge the battery 17 by using the electric power from the AC adaptor 122.

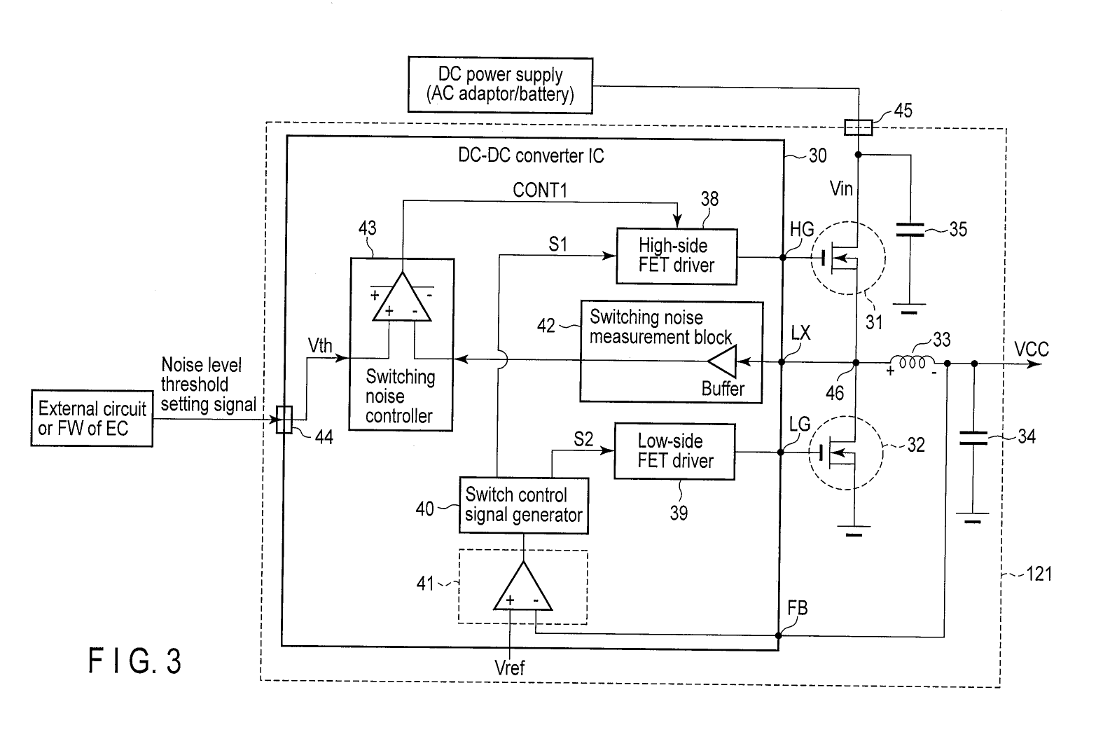

Next, the configuration of the switching regulator 121 of the embodiment will be explained with reference to FIG. 3.

The switching regulator 121 includes a DC-DC converter IC 30, a high-side transistor (high-side FET) 31, a low-side transistor (low-side FET) 32, inductor 33, a capacitor 34, and an output capacitor 35. The switching regulator 121 may also be mounted on a printed circuit board on which each component of the computer 10 is mounted.

In the embodiment, it is assumed that the switching regulator 121 is the step-down switching DC-DC converter as described previously. The switching regulator 121 is a synchronous rectification type DC-DC converter. The switching regulator 121 controls the switching of the high-side FET 31 and low-side FET 32 by the synchronous rectification method. The high-side FET 31 and the low-side FET 32 are connected in series between a power terminal 45 and reference potential (ground) terminal. The AC adaptor 122 or battery 17 applies an input voltage VIN to the power terminal 45. The input voltage VIN is converted into an output voltage VCC lower than the input voltage VIN by controlling the switching of the high-side FET 31 and the low-side FET 32 by the synchronous rectification method.

It is also possible to use, e.g., the PWM (pulse-width modulation) control method in order to alternately turn on and turn off the high-side FET 31 and the low-side FET 32 at a predetermined period (switching period). Details of the PWM control method will be described later. The output voltage VCC changes if duty ratio is changed in the PWM control method. For example, the output voltage VCC can be raised by increasing the ON-duty ratio of the high-side FET 31. The ON-duty ratio of the high-side FET 31 indicates the ratio of the ON period of the high-side FET 31 to the switching period.

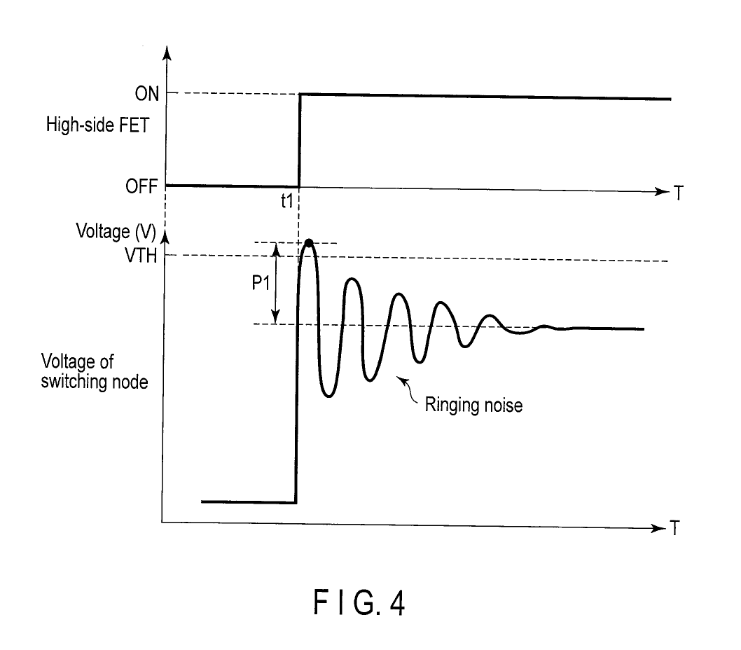

Also, in the embodiment, it is assumed that the switching is performed at a high speed. As described previously, therefore, the generation of the ringing noise as switching noise on a switching node 46 poses a problem. The switching node 46 is a connecting point of the high-side FET 31 and low-side FET 32. As described above, by the process evolution of the high-side FET 31, the switching speed is increasing recently. Accordingly, particularly the generated ringing noise may increase if the high-side FET 31 is turned-on. Details of the ringing noise will be described later with reference to FIG. 4.

The DC-DC converter IC 30 is connected to the high-side FET 31, low-side FET 32, the EC 119 or KBC, and the like. The DC-DC converter IC 30 is a controller configured to control the switching of the high-side FET 31 and low-side FET 32. The DC-DC converter IC 30 controls the switching of the high-side FET 31 and low-side FET 32 in accordance with the output voltage VCC, so that the value of the output voltage VCC is almost equal to a reference voltage Vref.

The DC-DC converter IC 30 includes a high-side FET driver 38, a low-side FET driver 39, a switch control signal generator 40, and an error amplifier 41. The switch control signal generator 40 and error amplifier 41 have function as a switching controller that outputs, in accordance with the output voltage VCC, first switch control signal S1 for controlling the switching of the high-side FET 31 and second switch control signal S2 for controlling the switching of the low-side FET 32. The first switch control signal S1 is sent to the high-side FET driver 38. The second switch control signal S2 is sent to the low-side FET driver 39.

The error amplifier 41 outputs an output voltage value corresponding to the difference between the reference voltage Vref and the output voltage VCC. The switch control signal generator 40 generates the first switch control signal S1 and the second switch control signal S2. Each of the first switch control signal S1 and the second switch control signal S2 are PWM signal. The ON-duty ratio of the first switch control signal. S1 is varied in accordance with the output voltage value from the error amplifier 41. The second switch control signal S2 may also be an inverted signal of the first switch control signal S1.

The high-side FET driver 38 turns on and turns off the high-side FET 31 in accordance with the first switch control signal S1. More specifically, the high-side FET driver 38 outputs an output signal (high-side gate driving signal) for driving the high-side FET 31, in accordance with the first switch control signal S1. The high-side gate driving signal is sent to the gate of the high-side FET 31 via a high-side gate terminal HG of the DC-DC converter IC 30.

The low-side FET driver 39 turns on and turns off the low-side FET 32 in accordance with the second switch control signal S2. More specifically, the low-side FET driver 39 outputs an output signal (low-side gate driving signal) for driving the low-side FET 32, in accordance with the second switch control signal S2. The low-side gate driving signal is sent to the gate of the low-side FET 32 via a low-side gate terminal LG of the DC-DC converter IC 30.

To reduce the ringing noise, the DC-DC converter IC 30 further includes a switching noise measurement block 42 and a switching noise controller 43. The switching noise measurement block 42 measures the switching noise. More specifically, the switching noise measurement block 42 has function as a detector configured to detect a ringing voltage on the switching node 46 via an input terminal Lx. The ringing voltage is, e.g., the peak value of the voltage of the ringing noise generated on the switching node 46. The switching noise measurement block 42 may also detect the peak value of the voltage on the switching node 46 as the ringing voltage described above. In this case, the switching noise measurement block 42 may also be implemented by a buffer circuit. The switching noise measurement block 42 send, to the switching noise controller 43, a signal indicating the measured ringing noise value, i.e., the ringing voltage, (switching noise notification).

The switching noise controller 43 is connected to the switching noise measurement block 42, the EC 119, and the high-side FET driver 38. The switching noise controller 43 functions as an adjusting module which, if the detected ringing voltage exceeds a threshold value, adjusts the level of the high-side gate driving signal of the high-side FET driver 38 so as to decrease the level of the high-side gate driving signal. The switching noise controller 43 and the switching noise measurement block 42 form a control loop for automatically adjusting the level of the high-side gate driving signal.

The switching noise controller 43 performs control that determines the output level which is output from the high-side FET driver 38 to the high-side FET 31, i.e., the level of the high-side gate driving signal (to be also referred to as a high-side output level hereinafter). The switching noise controller 43 notifies the high-side FET driver 38 of the determined high-side output level as a driver output level designation signal CONT1.

More specifically, the switching noise controller 43 compares the ringing noise value with a threshold value VTH based on the switching noise notification. The threshold value VTH is, for example, a value preset in the firmware of the EC 119. As the threshold value VTH (to be also referred to as a noise level threshold hereinafter), the value preset in the firmware of the EC 119 is transmitted as a noise level threshold setting signal from the EC 119 to the switching noise controller 43 via a threshold value setting terminal 44. Note that the noise level threshold setting signal can be either an analog signal or a digital signal.

Based on the result of the comparison of the ringing noise value with the noise level threshold, the switching noise controller 43 determines whether the ringing noise value is larger than the noise level threshold. For example, if the ringing noise value is larger than the noise level threshold, the switching noise controller 43 notifies the high-side FET driver 38 of a signal (the driver output level designation signal CONT1) for decreasing the high-side output level. If the ringing noise value is not larger than the noise level threshold, the switching noise controller 43 notifies the high-side FET driver 38 of, e.g., a signal (the driver output level designation signal CONT1) for increasing the high-side output level, or a signal (the driver output level designation signal CONT1) that does not change the high-side output level. The switching noise controller 43 can compare the ringing noise value with the noise level threshold by using, e.g., an operational amplifier.

The high-side output level of the high-side FET driver 38 can be varied by, e.g., adjusting the drivability of the high-side FET driver 38. The high-side FET driver 38 can also be implemented by a push-pull circuit including two FETs. In this case, the ON-resistance of a push FET (also called a high-side transistor or high-side driver) in the push-pull circuit can be varied in accordance with the driver output level designation signal CONT1. By thus adjusting the ON-resistance of the high-side transistor in the push-pull circuit forming the high-side FET driver 38, it is possible to control the drivability of the high-side FET driver 38, i.e., the amount of electric current flowing through the source-to-drain path of the high-side transistor in the push-pull circuit.

As described above, in the embodiment, since the control loop to be able to measure the switching noise (ringing noise) is formed, if the measured value exceeds the preset threshold value, the output level of the high-side FET driver 38 automatically is adjusted, thereby automatically reducing the ringing noise. By setting the threshold value at a value by which the above-described specific phenomenon does not occur, therefore, the output level of the high-side FET driver 38 can automatically be adjusted within a proper range so the above-described specific phenomenon does not occur.

The PWM control method of the switching regulator 121 will be explained below. Note that the PWM control method will be explained as an example of the switching control method in the embodiment, but a control method other than the PWM control method can also be used as the switching control method.

As described previously, the PWM control method controls switching by changing the duty ratio of a PWM signal, and performs control for, e.g., holding the output voltage value VCC constant. More specifically, it is assumed that the voltage of a node (output node) between the inductor 33 and the capacitor 34 is held constant. An LC filter circuit includes the inductor 33 and the capacitor 34, and the LC filter circuit functions as a smoothing filter. The error amplifier 41 receives the voltage value of the output node via an input terminal FB. The error amplifier 41 compares the received output node voltage value with a reference voltage value (VREF). The error amplifier 41 outputs an output voltage value corresponding to the difference between the output node voltage value and the VREF. More specifically, if the output node voltage value increases, the error amplifier 41 outputs an inverted amplification signal that decreases the output voltage value output from the error amplifier 41 to the switch control signal generator 40.

Based on the inverted amplification signal received from the error amplifier 41, the switch control signal generator 40 outputs different PWM control signals S1 and S2 to the high-side FET driver unit 38 and low-side FET driver unit 39, respectively. For example, if the output voltage value received via the input terminal FB decreases, the switch control signal generator 40 performs adjustment to decrease the duty ratio of the PWM control signal (high-side PWM control signal) S1 to be output to the high-side FET driver 38. Also, the switch control signal generator 40 outputs, e.g., a signal obtained by inverting the adjusted high-side PWM control signal S1 as the low-side PWM control signal S2 to the low-side FET driver 39, so that the low-side FET 32 is OFF when the high-side FET 31 is ON. The switch control signal generator 40 may also include an oscillator for generating a fixed-frequency reference signal for generating the PWM signals.

By controlling switching by the PWM control method, it is possible to adjust the duty ratio of PWM and hold the output node voltage value constant. The output voltage VCC of the switching regulator 121 is applied as operating power to each load in the system, e.g., the CPU 11 or another device.

An example of the change with time of the ringing noise generated before the high-side output level is adjusted will be explained below with reference to FIG. 4. FIG. 4 is a view showing the change in voltage of the switching node 46 in case that the high-side FET 31 is turned-on.

If the high-side FET 31 is turned-on at time t1, the ringing noise as switching noise is generated on the switching node 46. As shown in FIG. 4, the ringing noise is generated by the abrupt rise of the voltage on the switching node 46. As described previously, TH shown in FIG. 4 indicates a preset threshold value. Also, P1 shown in FIG. 4 indicates the peak value of the voltage of the ringing noise (the ringing voltage) before the high-side output level is adjusted. P1 shows that immediately after the ringing noise is generated, the peak value of the ringing voltage exceeds the predetermined threshold value. Then, the voltage value of the ringing noise decays while vertically oscillating. In the embodiment, the peak value as shown in FIG. 4 is measured, and it is determined whether the measured peak value is larger than the predetermined threshold value. Note that the voltage peak value itself on the switching node 46 can also be measured as the peak value P1 of the ringing voltage.

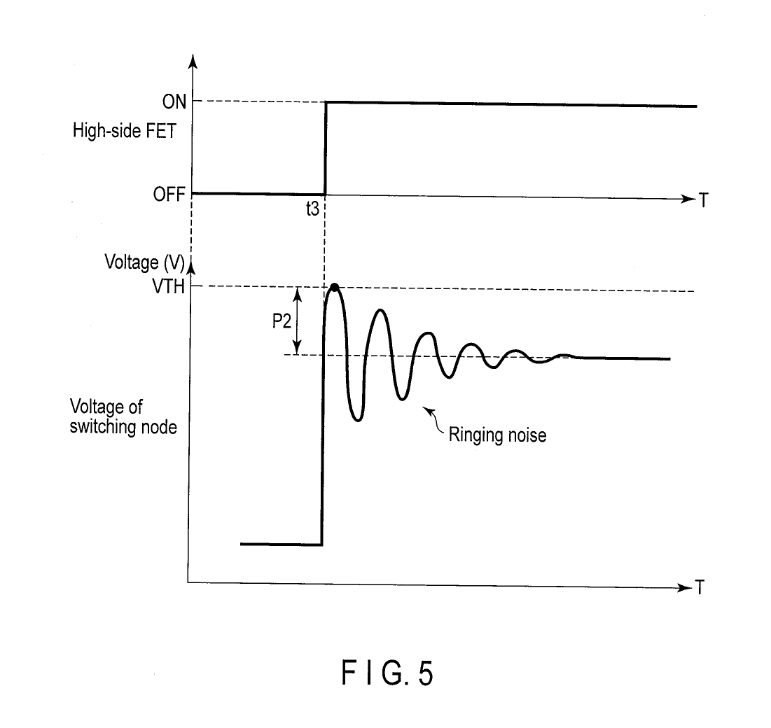

An example of the change with time of the ringing noise generated after the high-side output level is adjusted will be explained below with reference to FIG. 5. FIG. 5 is also a view showing the change with time of the voltage value of the ringing noise generated after the high-side output level is decreased. Note that an explanation of symbols, phenomena, and the like indicating the same contents as those shown in FIG. 4 will be omitted.

If the high-side FET 31 is turned-on at time t3, the ringing noise is generated on the switching node 46. P2 indicates the peak value of the ringing voltage after the high-side output level is adjusted. As shown in FIG. 5, P2 has the same value as that of VTH. By comparison of FIG. 4 and FIG. 5, it is revealed that the peak value of the ringing voltage decreases if the high-side output level is decreased.

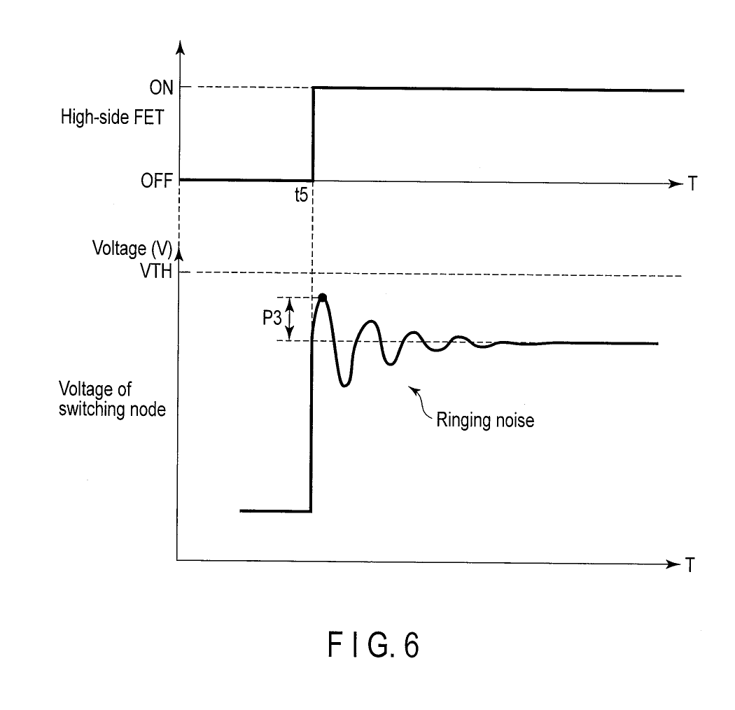

An example of the change with time of the ringing noise generated after the high-side output level is further adjusted will be explained below with reference to FIG. 6. FIG. 6 is also a view showing the change with time of the voltage value of the ringing noise generated after the high-side output level is further decreased.

If the high-side FET 31 is turned-on at time t5, ringing noise is generated on the switching node 46. P3 indicates the peak value of the ringing voltage after the high-side output level is further adjusted. As shown in FIG. 6, P3 has a value smaller than that of VTH. By the comparison of FIG. 5 and FIG. 6, it is revealed that the peak value of the ringing voltage further decreases if the high-side output level is further decreased.

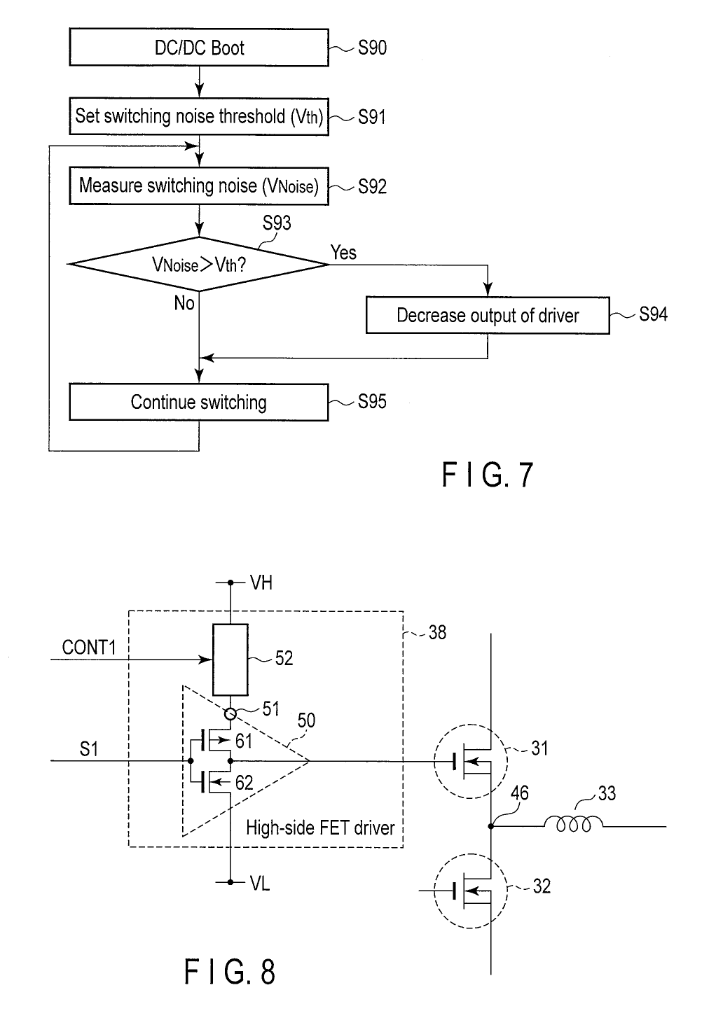

Next, the procedure of the ringing noise reducing process executed by the control loop in the DC-DC converter IC 30 will be explained with reference to a flowchart shown in FIG. 7.

First, the switching regulator 121 is activated (step S90). Then, the threshold value VTH is set in the switching noise controller 43 (step S91). The switching noise measurement block 42 measures the ringing noise (VNoise), i.e., the ringing voltage on the switching node 46 (step S92). Subsequently, the switching noise controller 43 compares the threshold value VTH with the ringing noise VNoise (step S93). If the value of the VNoise is larger than the value of VTH (YES in step S93), the switching noise controller 43 performs processing of decreasing the high-side output level of the high-side FET driver 38 (step S94). If the high-side output level is decreased, the process advances to step S95 to continue the switching operation (step S95). Then, the ringing noise (VNoise) is measured again in step S92.

By the above processing, the high-side output level of the high-side FET driver 38 is automatically adjusted so that the threshold value VTH and the ringing voltage become almost equal. Accordingly, the ringing voltage can automatically be reduced without inserting any resistance in series with the gate terminal of the high-side FET 31 or changing the layout of circuits of the DC-DC converter IC 30 after the switching regulator 121 is designed or manufactured.

Note that decreasing the high-side output level, i.e., decreasing the drivability of the high-side FET driver 38 may decrease the power efficiency of the switching regulator 121. In the embodiment, the high-side output level is adjusted such that the threshold value VTH and ringing voltage become almost equal. Therefore, the high-side output level can be controlled within a proper range by presetting the threshold value VTH at a proper value.

An example of the configuration of the high-side FET driver 38 will now be explained with reference to FIG. 8.

As described above, the high-side FET driver 38 outputs the high-side gate driving signal for driving (controlling the switching of) the high-side FET 31, based on the driver output level designation signal CONT1 received from the switching noise controller 43.

The switching noise controller 43 includes a buffer circuit 50 that operates as a push-pull circuit. The push-pull circuit includes transistor (FET) 61 and transistor (FET) 62. The two FETs 61 and 62 are connected in series between a positive power input terminal 51 and a negative power input terminal VL of the buffer circuit 50. As described previously, the drivability of the high-side FET driver 38 can be controlled by varying the ON-resistance of the FET 61 as the high-side FET in accordance with the driver output level designation signal CONT1. As shown in FIG. 8, an element 52 such as a variable-resistance element or variable-voltage-drop element can be inserted between a power terminal VH and the positive power input terminal 51. The drivability of the high-side FET driver 38, i.e., the ON-resistance of the FET 61 can be adjusted by varying the resistance value or voltage drop level of the element 52 in accordance with the driver output level designation signal CONT1.

In the embodiment as explained above, the ringing voltage on the switching node 46 is measured, and the level of the output signal from the high-side FET driver 38 in the switching regulator 121 is automatically adjusted such that the measured value becomes equal to or smaller than the threshold value. This makes it possible to reduce the ringing noise. This can also prevent the instability of the system caused by the switching noise. The switching noise is conventionally reduced by, e.g., inserting a series resistance in the gate terminal of a high-side switching element. In other words, in case of using this conventional method, it is necessary to insert the series resistance in the gate terminal or change the layout of circuits of the DC-DC converter IC 30, after the circuits of the DC-DC converter IC 30 are designed or manufactured. On the other hand, in the embodiment, the DC-DC converter IC 30 can be given the function of measuring the level of the switching noise, and varying the high-side output level if the measured level is larger than the preset threshold value. Accordingly, the switching noise can automatically be reduced without manually performing an operation of, e.g., changing the internal layout of the switching regulator 121, or inserting a resistance (gate series resistance) in series with the gate of the high-side FET 31. Therefore, the propagation of noise to, e.g., a system control signal can be prevented. In addition, the problem of the instability of the system can be eliminated. Furthermore, the same effect as effect of the case that the gate series resistance is inserted can be obtained by decreasing the high-side output level. Also, as described above, by the control loop, the high-side output level is automatically adjusted. In case that it is necessary to reduce the switching noise, therefore, it is possible to repetitively perform control for automatically adjusting the high-side output level. In the embodiment, control of decreasing the high-side output level is performed instead of inserting a series resistance in the gate of the high-side FET. Accordingly, the decrease in switching speed of the high-side FET can be made smaller than the decrease of a case that a series resistance is inserted in the gate of the high-side FET.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A switching regulator comprising:
a switching controller configured to output a first switch control signal for controlling switching of a high-side transistor and a second switch control signal for controlling switching of a low-side transistor;
a driver configured to supply an output signal for driving the high-side transistor to a gate of the high-side transistor in accordance with the first switch control signal;
a detector configured to detect a ringing voltage on a switching node between the high-side transistor and the low-side transistor; and
a switching noise controller configured to adjust a level of the output signal of the driver so as to decrease the level of the output signal if the detected ringing voltage exceeds a threshold value.

2. The regulator of claim 1,
wherein the switching noise controller is further configured to compare the detected ringing voltage with the threshold value, and to adjust drivability of the driver based on a result of the comparison.

3. The regulator of claim 1,
wherein the driver comprises a push-pull circuit, and
wherein the switching noise controller is further configured to compare the detected ringing voltage with the threshold value, and to adjust an ON-resistance of a high-side transistor in the push-pull circuit based on a result of the comparison.

4. The regulator of claim 1,
wherein the driver comprises a push-pull circuit, and
wherein the switching noise controller is further configured to compare the detected ringing voltage with the threshold value, and to adjust a voltage of a positive power terminal of the push-pull circuit based on a result of the comparison.

5. An electronic apparatus comprising:
a load; and
a switching regulator configured to supply electric power to the load,
wherein the switching regulator comprises:
a high-side transistor;
a low-side transistor;
a switching controller configured to output a first switch control signal for controlling switching of the high-side transistor and a second switch control signal for controlling switching of the low-side transistor in accordance with an output voltage of the switching regulator;
a driver configured to supply an output signal for driving the high-side transistor to a gate of the high-side transistor in accordance with the first switch control signal;
a detector configured to detect a ringing voltage on a switching node between the high-side transistor and the low-side transistor; and
a switching noise controller configured to adjust a level of the output signal of the driver so as to decrease the level of the output signal if the detected ringing voltage exceeds a threshold value.

6. The apparatus of claim 5,
wherein the switching noise controller is further configured to compare the detected ringing voltage with the threshold value, and to adjust drivability of the driver based on a result of the comparison.

7. The apparatus of claim 5,
wherein the driver comprises a push-pull circuit, and
wherein the switching noise controller is further configured to compare the detected ringing voltage with the threshold value, and to adjust an ON-resistance of a high-side transistor in the push-pull circuit based on a result of the comparison.
